(19) United States
(12) Patent Application Publication
(10) Pub. No.: US 2021/0115780 A1
(43) Pub. Date: Apr. 22, 2021

(54) SUBSEA STRUCTURE MONITORING SYSTEM

(71) Applicant: WFS Technologies Limited, Livingston (GB)

(72) Inventor: Brendan Peter Hyland, Edinburgh (GB)

(73) Assignee: WFS Technologies Limited, Livingston (GB)

(21) Appl. No.: 16/494,046

(22) PCT Filed: Mar. 15, 2018
(86) PCT No.: PCT/EP2018/056466

§ 371 Date: Sep. 13, 2019

(30) Foreign Application Priority Data
Mar. 14, 2017 (GB) 1704075.9
Apr. 13, 2017 (GB) 1706037.7

(51) Int. Cl. E21B 47/001; E21B 47/01; E21B 47/12

(52) U.S. Cl. CPC E21B 47/001; E21B 47/12; E21B 47/01

(57) ABSTRACT

A subsea structure monitoring system comprising a plurality of sensor nodes distributed across the subsea structure, each wireless node comprising a sensor unit, a processor unit, and transmission unit wherein the sensor unit comprises at least one sensor which is operable to measure at least one environment variable, the sensed data is processed by the processor unit and is operable to be transmitted onwards to a transmission unit.

The invention relates to a riser monitoring system and in particular to a wireless riser monitoring system.

Subsea structures are subject to a variety of localised pressures and currents which can cause wear and tear and weaken their integrity. For example, a steel catenary riser located in water depths up to 2000 m and configured in a lazy wave will, at differing depths be subjected to different currents as they occur in stratified layers within the ocean body. These different currents can also vary from movement, for example on the surface layers generated, by storm conditions. The differing currents can act to generate further strain upon the subsea structure as different forces can be acting on different sections of the structure creating inter-structure strain as well as the strain of the force itself.

Such wear and tear can severely limit the lifespan of a subsea structure and, with no manner in which to effectively assess the damage occurring, in order to prevent failure of the structure, the lifespan must be underestimated. Conservative estimation of the lifespan can mean replacement of a structure long before it's working life is anywhere near at its limit and therefore, when objective of a structure, such as, for example, a riser is to move hydrocarbons from seabed to topside at the lowest cost per barrel, underestimating the riser lifespan means that the capital cost per barrel for the structure is higher than necessary.

Looking specifically at a riser, such a structure is subject to a range of factors that impact its useful life. These include fatigue due to movement such as storms, water currents, vortex induced vibration (VIV), self-induced flow movements, flow induced vibration (FIV), fatigue due to temperature changes, corrosion due to oxidation from outside, internal corrosion due to the process, and the effect process conditions including slugging, changes in water current or the like.

For example, during the life of a riser, it is subject to changes in process flows such as flow rates, chemical composition, temperature of fluid within the riser and so on. The riser is also subject to changing environmental conditions such as surrounding water temperature, water currents, storms or the like. It is widely appreciated that a riser can become subject to blockages, or slugging, due to issues such as the build up of wax and/or hydrates. During production, the multi-phase flow, meaning flow of a mixture of water, gas and hydrocarbons occurs in the riser. Depending on the composition and volume of these elements, there is potential for flow to be disrupted if one of these elements is more prevalent. This can introduce slugging in the riser which can decrease production efficiency and impact on the minimum band radius of the riser thus impacting riser integrity through premature fatigue conditions occurring.

Yet, in the face of such wear and tear, it is desirable that riser use can be optimised for maximum throughput or extended life. With no useful and cost effective manner of assessing structural integrity, caution is essential and therefore replacement of parts must occur well before any risk of failure arises. As a result, conservative assessments of lifespan and swapping out of still viable components occurs at a far earlier stage adding excess cost and increased structural wastage burdens to the cost overheads.

It is therefore an object of the present invention to provide a subsea structure monitoring system which overcomes these and other issues.

According to a first aspect of the invention there is provided a subsea structure monitoring system comprising a plurality of sensor nodes distributed across the subsea structure, each wireless node comprising a sensor unit, a processor unit, and transmission unit wherein the sensor unit comprises at least one sensor which is operable to measure at least one environment variable, the sensed data is processed by the processor unit and is operable to be transmitted onwards to a transmission unit.

Preferably, the wireless nodes further comprises a memory unit operable to store sensed data, and/or processed sensed data, prior to transmission by transmission unit.

The monitoring system may further comprise a topside processing unit operable to received data transmitted by sensor nodes.

Preferably the topside processing unit is operable to transmit command and control data to a sensor node.

Preferably each sensor node comprises at least one sensor selected from the list of a temperature sensor for measuring seawater temperature, and ultrasonic thickness sensor, an accelerometer, a pressure sensor, an ultrasonic flow sensor, a seawater current sensor and a cathodic protection sensor.

Embodiments of the present invention will now be described with reference to the following figures, by way of example only, in which:

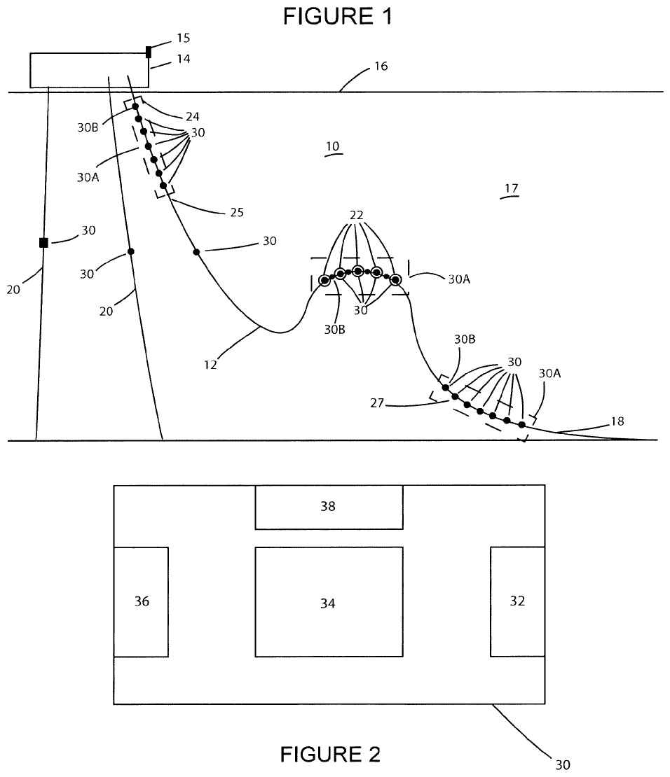

FIG. 1 shows a deployed subsea structure monitoring system in accordance with an embodiment of the present invention; and

FIG. 2 shows a schematic diagram of a sensor node for use the monitoring system in accordance with an embodiment of the present invention,

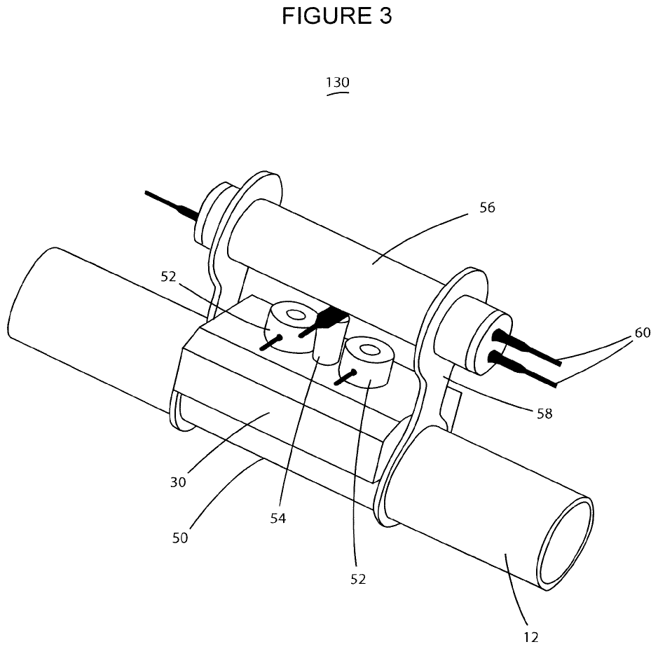

FIG. 3 shows a sensor node clamp arrangement for use in the monitoring system in accordance with an embodiment of the present invention, and

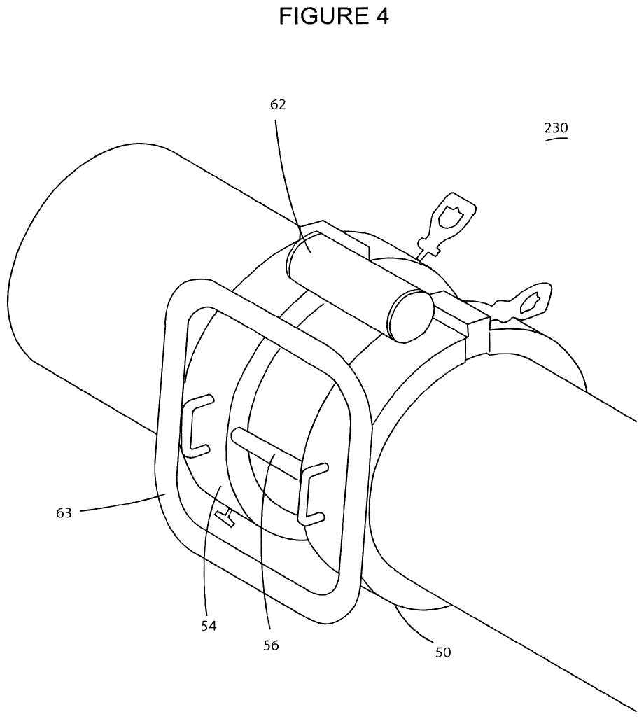

FIG. 4 shows a sensor node clamp arrangement for use in the monitoring system in accordance with an embodiment of the present invention.

In FIG. 1 there is shown a fully integrated subsea structure monitoring solution 10 utilizing Subsea Internet of Things architecture. In this case the subsea structure is a steel catenary riser 12 located in water depths up to 2000 m offshore and configured in a lazy wave. A fully integrated riser monitoring system is integrated as part of the riser structure system 12 which hangs of floating production and storage offloading platform (FPSO) 14 arranged at the sea surface 16. The riser 12 extends from the FSPO 14 to sit on seabed 18. Buoyancy modules 22 are provided on the riser 12 to support It in the sea 17 between the FSPO 14 and the seabed 18. The FSPO 14 is moored to the seabed by mooring lines 20.

The system 10 comprises a plurality of sensor node 30 with groupings of sensor nodes 30A deployed on sections of the riser 12 which are most likely to experience increases stresses of environmental strain. In this embodiment, groupings of sensor nodes 30A are found between hang off 24 and upper catenary 25, at sag bend 26 and at touchdown zone 27. Individual sensor nodes 30 are also deployed on mooring lines 20 at areas of risers were collision between the riser 12 and the mooring line 20 may occur, thus enabling any potential clashing of the underwater structures, and the potential effect of this, to be monitored.

As is shown in FIG. 2, each sensor node 30 comprises a communication unit 32 which incorporates at least one of radio, acoustic and optical wireless communications and preferably comprises a hybrid system comprising one or more of transmitters for these different transmission types which allows for tow way wireless communication The sensor node 30 further comprises a core processor 34 and a sensor unit 36 which incorporates one or more sensors such as, but not limited to sensors for measuring seawater temperature, ultrasonic thickness (UT), accelerometer, pressure and optionally process flow using ultrasonic flow (UF), seawater current and cathodic protection (CP). A power supply, in this case battery unit 38, is also included in sensor node 30 and a memory unit (not shown) may optionally be included should the node be programmed to obtain readings which are not transmitted onwards on each occasion a reading is made. The system 10 further comprises a processor system 15 located on FSPO 14. The topside processor system 15 will include a communications unit operable to receive data from and transmit data to sensor nodes 30 enabling two-way control of critical parameters and alarm thresholds.

Controller nodes 30B are provided within node groups 30A will collect information from a network of local sensor nodes using radio communication techniques and retransmit between different riser regions 24, 25, 26, 27 using acoustic communications. Other nodes 30 may be operable as relay nodes to transmit data long riser 12 to controller node 30B.

Whilst each node 30 is provided with a communications unit 32 operable to transmit and receive wireless data using optical and/or acoustic and/or electromagnetic signals, in addition, within each sensor node grouping 30A, the sensor nodes 30 may be connected by cable. However, at least one of the sensor nodes in sensor node group 30A, in this embodiment sensor node 30B, is the control node and is operably to collate through cable or wireless received data from the other nodes 30. The sensor node 30B then wirelessly transmits the sensed and processed data onwards to the topside processor 15. Topside processor 15 can then use the received data for further analysis, actuation of control or command signals if required and, should it be necessary, for further processing.

Each sensor node 30 core processor 34 is formed such that the system 10 is able to incorporate use of data processing algorithms to convert raw sensor data to critical information. For example, in this embodiment, each sensor node 30 be a hybrid communication smart controller, with communication unit 32 comprising a Wi-Fi and acoustic communications module, the sensors unit 36 including a cathode protection sensor, an external environmental sensor measuring local current speed, accelerometers, inclination sensors, one or more ultrasonic flow sensors, process temperature sensors, and an ultrasonic thickness sensor. The sensor node 30 may be incorporated as part of a smart clamp. It will be appreciated that strain sensors may also be incorporated in the sensor unit 36. The smart clamp construction of the sensor node 30 may be of particular value in minimizing the cost of deployment of the sensor nodes 30 to form system 10, particularly when they are to be retrofitted to a structure 12.

The sensor nodes 30 in sensor node groups 30A will be spaced apart, for example at approximately 30 m apart.

The network of sensor nodes 30 are chosen to provide salient data for the structure being monitored. For example, sensor units 30 can be provided with accelerometers and/or inclinometers will obtain data that can determine the shape of the riser 12 during significant storms as well as during normal operation. Temperature sensors can monitor process and water temperature; pressure sensors will monitor riser depth and vertical movement. UT sensors will can monitor long term corrosion and optional flow sensors will monitor water currents.

Using an appropriate combination of sensors within sensor units 36, the monitoring system 10 will be operable to provide regular information on criteria such as, for example, fatigue, VIV, flow assurance and corrosion. Critical parameter readings relating to these criteria as determined from the sensor measurements and subsequently processed data are transmitted to a top side controller 15. An artificial intelligence (AI) engine is located at the FSPO, which may be a Riser Control Station, and this may be, for example, a laptop located in the FPSO 14 which uses an operating system such as Xprop or similar algorithms to analyse critical information from nodes 30 to develop and optimise one or more system models, adjust sensor sampling rates, and adjust data processing algorithms at each smart sensor node 30 to improve performance, efficiency and reliability.

The system 10 will provide information on fatigue by having sensors such as accelerometers and inclinometers to measure instantaneous and cumulative fatigue at each monitored region of the riser. The strain within the riser will be inferred from the sensed data and fatigue damage at each measurement point calculated. The system will obtain information on VIV by the sensor nodes 30 through measurement of external current. This sensed data will provide an indication of the likelihood of VIV and the data can be used as input to VIV models at the processor 15 for estimations of VIV fatigue damage.

The system 10 will provide information on flow assurance by way of temperature sensors in sensor units 36 determining the process temperature gradient and this sensed data will then be processed by core processor 34 to give an output which allows possible wax/hydrate build-up to be determined.

The system 10 can provide information useful in enabling corrosion to be monitored and managed by determining riser wall thickness at each node 30 to obtain an accurate output indicating corrosion rates at each monitored region of the riser 12.

Battery management is key to extension of lifetime cost of remote wireless system and use of a two-pronged approach using battery management technology will ensure relevant data is collected during significant event such as, in this embodiment, a storm event, as well as logging data on a regular basis so that ongoing status can be determined. The topside unit 15 will be, for example, provided with an integrated with the weather reporting system. Daily forecasts will be analysed by the topside processor unit 15 to determine the likelihood of a significant storm event in the next 24 hours. If a significant storm is forecast, the timing of this will be communicated to the sensor nodes 30 through, for example, a short duration daily acoustic communications link. It will be appreciated that although an acoustic link is suggested, an electromagnetic or optical communication link could be used. This daily synchronisation will allow clock syncing between processor unit 15 and nodes 30 as well as determining the periods during the next 24 hours that the sensor nodes 30 should be on active duty cycle.

A secondary battery management system can also be put in place whereby each node 30 will listen for significant events at pre-defined intervals in sequence which will allow unpredicted weather events to be captured. Should a significant event be detected during this listening period, a wake-up signal will be sent to the other nodes 30 for data collection.

Battery life of each node 30 is further extended by local data processing in core processor 34. Sensor data from each sensor unit 36 will be processed locally by core processor 34 and critical information transmitted via communication unit 32 to adjacent nodes 30 for cumulative fatigue processing. Riser fatigue information may, for example, then be relayed acoustically to controller nodes 30B located in this example below the splash zone. These nodes will retransmit fatigue information through the sea-air interface to the FPSO using radio transmission. It will also be appreciated that raw data may be recovered from nodes 30 by an ROV.

In use, the system 30 will be set to report fatigue damage on a regular basis, for example, in this embodiment, on a weekly basis, with cumulative fatigue damage recorded on a memory (not shown) housed in the core processor prior to being transmitted to the topside processing unit 15 where it is received and reported to operators via a user interface. Furthermore, the wall thickness at each of the nodes will be measured and reported, for example, monthly giving detailed data on the internal corrosion rate at each of the riser sections being monitored allowing the output from the processing unit to be input into asset integrity management systems. The minimum and maximum temperature of the riser will also be reported on a daily basis allowing for the processor unit 15 output to be provided to the flow assurance teams to minimize or prevent any wax build up or the formation of hydrate plugs.

In one embodiment, the AI model located in the topside processor unit 15 will be used to determine optimum settings to optimise for example, throughput and/or riser life and/or cost per barrel.

In one embodiment of the system 10, AI models will be implemented within remote sensors distributed across the structure in order to improve overall system power management.

In implementing the smart riser system, it will be possible to optimise process flows to match weather conditions, for example, pushing maximum flow during heavy storms is likely to have a disproportionately adverse impact on fatigue and therefore the system 10 will provide data to the control system 15 to indicate that a lower flow rate is advisable at that particular time and control system 15 can then send command data to the riser operating mechanisms to reduce flow. It will also be possible to use output data to optimise flow within the riser to match water current patterns and optimise flow within the riser to extend useful life of the riser 12 and provide an accurate estimate of given end of life determined by fatigue and/or corrosion. It will also be possible to optimise the production system against historic and predicted weather conditions.

For example, slugging can typically be identified as a number of discrete pulses of approximately 10 seconds duration in the flow with slugging events typically lasting up to 3 hours. By monitoring sensor node group 30A at the sag bend 26 of the riser 12, it is possible to identify when slugging is occurring thus identifying potential breaches of the riser minimum bend radius (MBR) which could impact it's integrity.

The riser monitoring system 10 is configured to allow evaluation of the riser MBR at sag bend 26 during normal operation and during slugging by measuring and recording riser inclination. This data will be processed locally at core processor 34 and used to calculate the bend radius of the catenary 12 between the sensors 30. An alarm signal will be output by node 30B to topside processor 15 in the event of a breach of pre-defined MBR thresholds. The topside processor control unit 15 will accept riser flow data from nodes 30B. The onset of slugging is identified by a step reduction in flow. This will trigger transmission of a control signal from processor unit 15 to the sensor nodes 30 to wake up from a sleep mode and to begin monitoring. Once normal flow has been resumed, the nodes 30 will be placed by into sleep mode with instruction only to wake and measure the desired data at the previously predetermined interval. During the occurrence of slugging, the data received by the processor 15 from the monitor nodes 30A at the bend 26 is able to be used to activate control signals which modify production rate to minimize the potential damage caused by slugging.

In FIG. 3 there is shown a sensor node 30 integrated in a clamp 50 to form a smart clamp node 130 which could operate as a sensor node in the system of FIG. 1, these smart clamp sensor nodes 130 which enable deployment and subsequent self-monitoring in situ by a light class ROV. Prior to retrofitting by a diver or an ROV, it is important that the risers and mooring lines are free from bio-fouling and suitably prepared for securing of the clamps. The structure of the clamp node 130 is such that it is of light construction enabling a quick change of the clamped node 130 if necessary.

Smart riser clamps 130 can be used for both new risers and retrofitted to older risers and will utilise, as described with reference to FIG. 1, a combination of sensor monitoring, local data analytics, implementation of AI (artificial intelligence) and hybrid wireless communication techniques in order to optimise the operation of the smart riser system. In this embodiment, the clamp 50 incorporates sensor node 30 which includes a vibration monitor 56 secured to the clamp body by a rigid vibration clamp 58, ultrasonic flow sensors 52, a temperature sensor 54. The smart clamp 130 is, in this case, provided with cable connections 60. Core processor (not shown) processes sensed data locally to correct predictive models relating to criteria such as fatigue, corrosion or flow. The arrangement of the sensors 52, 54 and 56 are such that they are suitable for slotting in and out whilst the clamp node 130 remains in situ.

In FIG. 4 a further embodiment of a smart clamp node 230 is shown wherein the node 30 communication unit 32 includes an externally mounted electromagnetic transmission unit 62 and associated antenna 63. In this embodiment each node 230 would form part of a fully integrated riser monitoring solution (not shown) utilizing Subsea Internet of Things architecture will be integrated as part of the riser system. The nodes 230 will have hybrid wireless communication units which incorporate radio via transmission unit 62 and antenna 63, acoustic and optical communications (not shown) as well as a core processor (not shown). In addition, the sensor unit will include sensors to monitor seawater temperature, an ultrasonic thickness sensor, an accelerometer, a pressure sensor and optionally process flow sensor using an ultrasonic flow sensor, a seawater current sensor and cathodic protection (CP) sensors. The core processor will incorporate data processing algorithms to convert raw sensor data to critical information. The network of wireless nodes will, for example, be able to determine the shape of the catenary 12 during significant storms. The temperature sensors will monitor process and water temperature, the pressure sensor will monitor riser depth and vertical movement, the UT sensors will monitor long term corrosion and optional flow sensors will monitor water currents.

In some embodiments it will be possible for a fatigue management model to provided in the core processor of each monitoring node 30 wherein the fatigue management model is able to be customized to match the characteristics of the specific riser to which it is affixed. If is also possible for a custom user interface to be generated either on control nodes 30 or on processor unit 15. Incorporation of the sensor system into a subsea structure assembly can enable a full automation achieving an integrated subsea internet of things structure thus achieving a substantial reduction in operations and capital expenditure costs as a result of increased lifespan of subsea structures, reduced inspection requirement and associated costs and reduced systemic risk.

The principle advantage of the invention is real time fatigue data can be established across the length of a subsea structure without the need for wired communication techniques being used.

A further advantage of the invention is that as a smart riser monitoring system, the sensor system monitors the relevant variables to collect data to be used to provide information on optimal process settings.

A further advantage of the invention is that a hybrid wireless communication system incorporating two or more of electromagnetic, acoustic or optical means that the system nodes will can continue to communicate regardless of the state of the surrounding environment.

It will be appreciated to those skilled in the art that various modifications may be made to the invention herein described without departing from the scope thereof. For example, it will be appreciated that in each embodiment of the sensor system, the performance may be optimised using multi-variable control techniques. In addition, the system need not be restricted to FSPO platforms but may be associated with any subsea structure including, but not limited to, oil platforms, vessels, communication cables or other subsea infrastructure for which subsea monitoring and control would be advantageous. In addition, relay nodes may be interspersed between sensor nodes to aid in the onward transmission of data from and to each sensor node.

1. A subsea structure monitoring system comprising a plurality of sensor nodes distributed across the subsea structure, each wireless node comprising a sensor unit, a processor unit, and transmission unit wherein the sensor unit comprises at least one sensor which is operable to measure at least one environment variable, the sensed data is processed by the processor unit and is operable to be transmitted onwards to a transmission unit.

2. A monitoring system as claimed in claim 1 wherein the wireless nodes further comprises a memory unit operable to store sensed data, and/or processed sensed data, prior to transmission by transmission unit.

3. A monitoring system as claimed in claim 1 further comprising a topside processing unit operable to received data transmitted by sensor nodes.

4. A monitoring system as claimed in claim 1 wherein the topside processing unit is operable to transmit command and control data to a sensor node.

5. A monitoring system as claimed in claim 1 wherein each sensor node comprises at least one sensor selected from the list of a temperature sensor for measuring seawater temperature, and ultrasonic thickness sensor, an accelerometer, a pressure sensor, an ultrasonic flow sensor, a seawater current sensor and a cathodic protection sensor.
